(19) United States
(12) Patent Application Publication
(10) Pub. No.: US 2006/0016908 A1
(43) Pub. Date: Jan. 26, 2006

(54) Shower head assembly

(75) Inventor: Chin-Tang Chung, Lu Kang Chen (TW)

Correspondence Address: NIKOLAI & MERSEREAU, P.A., 900 SECOND AVENUE SOUTH, SUITE 820, MINNEAPOLIS, MN, 55402, US

(73) Assignee: Shong I Copper Co., Ltd., Lu Kang Chen (TW)

(21) Appl. No.: 10/894,495

(22) Filed: Jul. 20, 2004

(51) Int. Cl. B05B 15/06

(52) U.S. Cl. 239/273; 239/275; 239/282; 239/283

(57) ABSTRACT

A shower head assembly includes a main body, a locking seat, a locking nut, a mounting disk, a water outlet panel, a sealing ring, and an adjusting bolt. Thus, the mounting disk and the water outlet panel are pulled to move upward by rotation of the adjusting bolt to closely press the sealing ring between the end flange of the main body and the support section of the water outlet panel, so that the water outlet panel is combined with the main body closely without producing leak, thereby providing a sealing effect efficiently.

### BACKGROUND OF THE INVENTION

1. Field of the Invention

The present invention relates to a shower head assembly, and more particularly to a shower head assembly attached to a wall.

2. Description of the Related Art

A conventional shower head comprises a main body attached to a wall, and a water outlet panel mounted on the main body and formed with a plurality of water outlet holes. However, the main body and the water outlet panel are integrally combined with each other in a rolling press manner, so that the water outlet panel cannot be detached from the main body, thereby causing inconvenience to a user in maintenance of the inside of the water outlet panel.

The closest prior art of the conventional shower head was disclosed in U.S. Pat. No. 6,241,166. However, when the rotation bolt 38 is rotated to pull the inner shade 8 and the water outlet panel 10 to press the sealing ring 16, the inner shade 8 is easily deformed or distorted due to the stress to form a gap between the water outlet panel 10 and the inner shade 8, thereby producing leakage. In addition, the water outlet panel 10 and the inner shade 8 are integrally combined with each other in a riveting manner, so that the water outlet panel 10 cannot be detached from the inner shade 8, thereby causing inconvenience to a user in maintenance of the inside of the water outlet panel 10.

### SUMMARY OF THE INVENTION

In accordance with the present invention, there is provided a shower head assembly, comprising a main body, a locking seat, a water outlet panel, a mounting disk, and an adjusting bolt, wherein:
the main body has a central portion formed with a mounting recess having a side formed with a positioning hole;
the locking seat is mounted on the main body and has a first end formed with a mounting portion secured in the positioning hole of the main body and having a peripheral wall formed with a plurality of water inlet holes each communicating with an inside of the main body;
the water outlet panel is mounted on the main body and has a surface formed with a plurality of water outlet holes each communicating with the inside of the main body;
the mounting disk has a central portion formed with a column having an inside formed with a screw bore, a peripheral wall formed with an annular fixing ring secured on the water outlet panel and an intermediate portion formed with an annular mounting ring located between the column and the fixing ring; and
the adjusting bolt is rotatably mounted in the mounting portion of the locking seat and has a distal end screwed into the screw bore of the column of the mounting disk to pull the mounting disk and the water outlet panel to move upward.

The primary objective of the present invention is to provide a shower head assembly, wherein the mounting disk and the water outlet panel are pulled to move upward by rotation of the adjusting bolt to closely press the sealing ring between the end flange of the main body and the support section of the water outlet panel, so that the water outlet panel is combined with the main body closely without producing leak, thereby providing a sealing effect efficiently.

Another objective of the present invention is to provide a shower head assembly, wherein the mounting disk is combined with the water outlet panel, and the mounting ring of the mounting disk provides a hanging effect during the plating process, thereby facilitating the plating working process of the shower head assembly.

A further objective of the present invention is to provide a shower head assembly, wherein the mounting disk and the water outlet panel are removed from the main body by rotation of the adjusting bolt, thereby facilitating a user cleaning the water outlet holes and the nozzles of the water outlet panel.

A further objective of the present invention is to provide a shower head assembly, wherein the water directly flows through the water inlet holes of the locking seat into the inside of the main body, and directly flows outward from the water outlet holes and the nozzles of the water outlet panel, so that the water flow rate is smooth and constant.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a shower head assembly in accordance with the preferred embodiment of the present invention;

FIG. 2 is an exploded perspective view of the shower head assembly as shown in FIG. 1;

FIG. 3 is a plan cross-sectional view of a locking seat of the shower head assembly taken along line 3-3 as shown in FIG. 2;

FIG. 4 is a plan cross-sectional view of a water outlet panel of the shower head assembly taken along line 4-4 as shown in FIG. 2;

FIG. 5 is a plan cross-sectional view of the shower head assembly as shown in FIG. 1; and

FIG. 6 is a schematic operational view of the shower head assembly as shown in FIG. 5 in use.

### DETAILED DESCRIPTION OF THE INVENTION

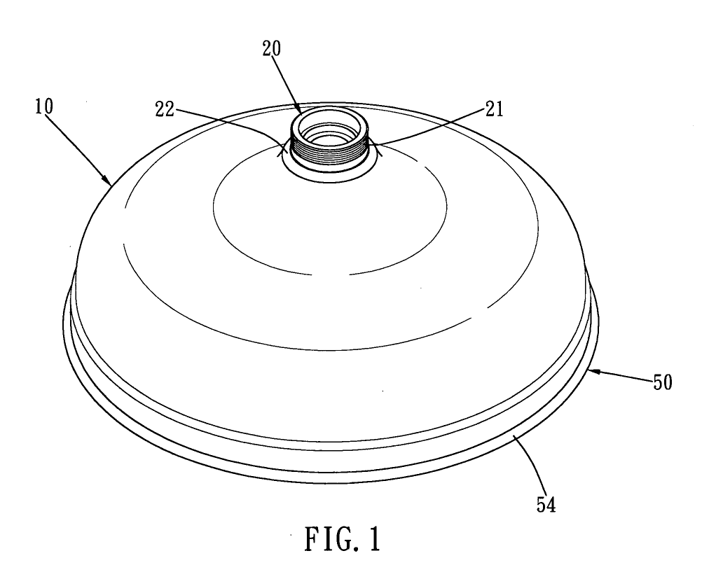

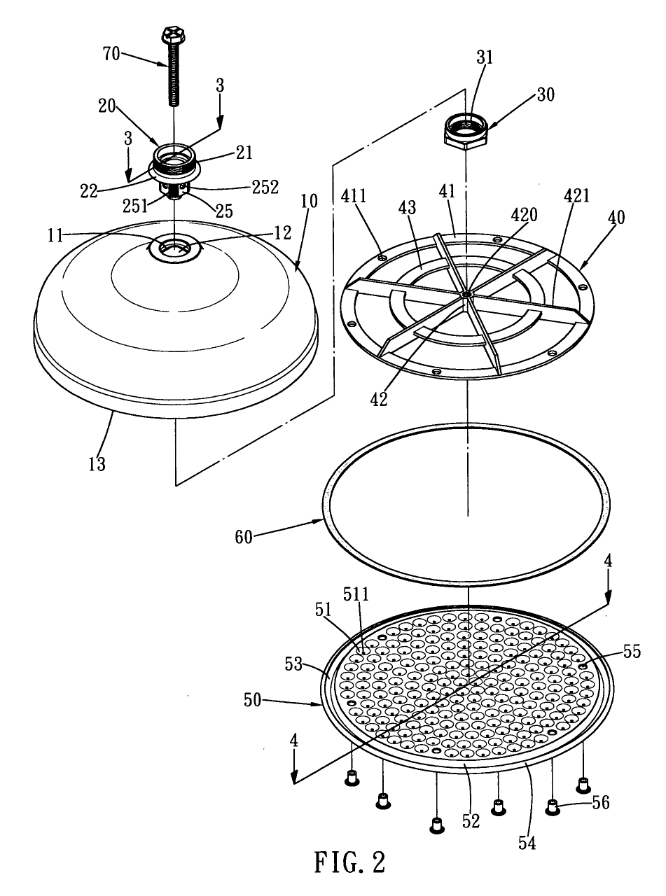

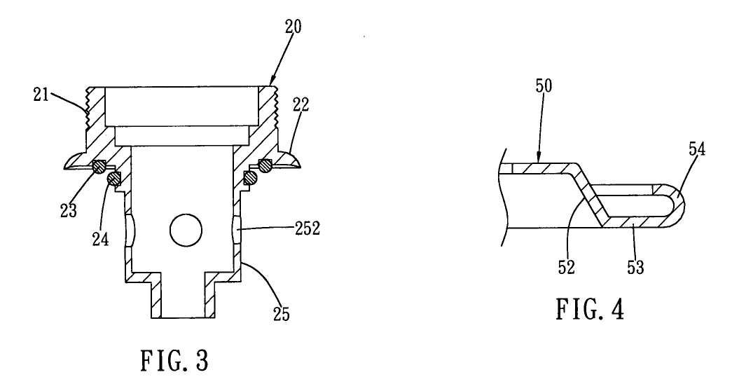

Referring to the drawings and initially to FIGS. 1-5, a shower head assembly in accordance with the preferred embodiment of the present invention comprises a main body 10, a locking seat 20, a locking nut 30, a mounting disk 40, a water outlet panel 50, a sealing ring 60, and an adjusting bolt 70.

The main body 10 has a central portion formed with a circular mounting recess 11 having a side formed with a positioning hole 12. The positioning hole 12 of the main body 10 has a square shape and has four chamfered corners. The main body 10 has a central portion formed with a peripheral wall formed with an end flange 13 disposed at an upright state.

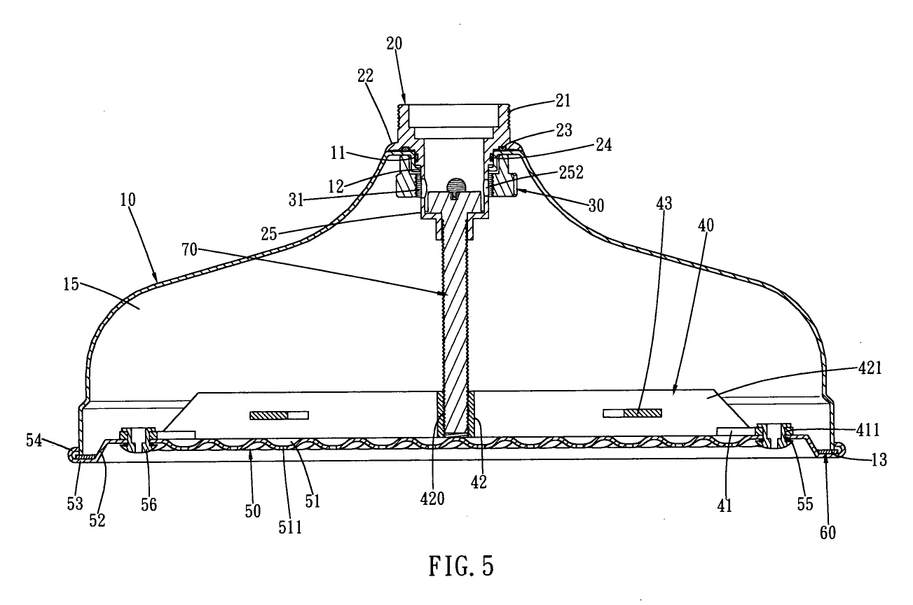

The locking seat 20 is mounted on the main body 10 and has a triple-stepped cylindrical shape. The locking seat 20 has a first end formed with a mounting portion 25 secured in the positioning hole 12 of the main body 10 and having a peripheral wall formed with a plurality of water inlet holes 252 each communicating with an inside 15 (see FIG. 5) of the main body 10. The mounting portion 25 of the locking seat 20 has a stepped-shape cross-section and is inserted into the mounting recess 11 of the main body 10. An O-ring 23 is mounted on a side of the mounting portion 25 of the locking seat 20 and urged on a wall of the mounting recess 11 of the main body 10. The mounting portion 25 of the locking seat 20 has a square shape and has four chamfered corners to match a profile of the positioning hole 12 of the main body 10. Each of the four chamfered corners of the mounting portion 25 of the locking seat 20 is formed with an outer threaded section 251. The locking seat 20 has a mediate portion formed with a substantially arc-shaped abutment 22 rested on a top of the main body 10. An O-ring 23 is mounted on a side of the abutment 22 of the locking seat 20 and urged on the main body 10. The locking seat 20 has a second end formed with an outer thread 21.

The locking nut 30 is mounted in the main body 10 and secured on the mounting portion 25 of the locking seat 20 to fix the locking seat 20 on the main body 10, so that the main body 10 is urged between the locking seat 20 and the locking nut 30. The locking nut 30 has a stepped shape and has an inside formed with an inner thread 31 screwed onto the outer threaded sections 251 of the mounting portion 25 of the locking seat 20.

The water outlet panel 50 is mounted on the main body 10 and has a surface formed with a plurality of circular recesses 51 each formed with a water outlet hole 511 each communicating with the inside 15 of the main body 10. The water outlet panel 50 has an edge formed with a plurality of through holes 55. The water outlet panel 50 has a peripheral wall formed with an oblique section 52 having a distal end formed with a horizontal support section 53 rested on the end flange 13 of the main body 10 and having a distal end formed with a hook-shaped upward curved snapping section 54 snapped onto the end flange 13 of the main body 10.

The sealing ring 60 is mounted between the end flange 13 of the main body 10 and the support section 53 of the water outlet panel 50.

The mounting disk 40 is secured on the water outlet panel 50 and received in the main body 10. The mounting disk 40 has a central portion formed with a column 42 having an inside formed with a screw bore 420, a peripheral wall formed with an annular fixing ring 41 secured on the water outlet panel 50 and an intermediate portion formed with an annular mounting ring 43 located between the column 42 and the fixing ring 41. The mounting ring 43 of the mounting disk 40 is located at a level greater than that of the fixing ring 41 as shown in FIG. 5. The column 42 of the mounting disk 40 has a peripheral wall formed with a plurality of radially arranged connecting ribs 421 each extended through and combined with the mounting ring 43 and the fixing ring 41 to connect the column 42, the mounting ring 43 and the fixing ring 41. The fixing ring 41 of the mounting disk 40 has a peripheral wall formed with a plurality of fixing holes 411 combined with the through holes 55 of the water outlet panel 50 by a plurality of nozzles 56.

The adjusting bolt 70 is rotatably mounted in the mounting portion 25 of the locking seat 20 and has a distal end screwed into the screw bore 420 of the column 42 of the mounting disk 40 to pull the mounting disk 40 and the water outlet panel 50 to move upward.

In operation, referring to FIGS. 1-6, the locking seat 20 is mounted on a universal connector 90 which is mounted on a wall (not shown). An urging nut 80 is mounted on the universal connector 90 and is screwed onto the outer thread 21 of the locking seat 20, and an O-ring 81 is urged between the locking seat 20 and the universal connector 90.

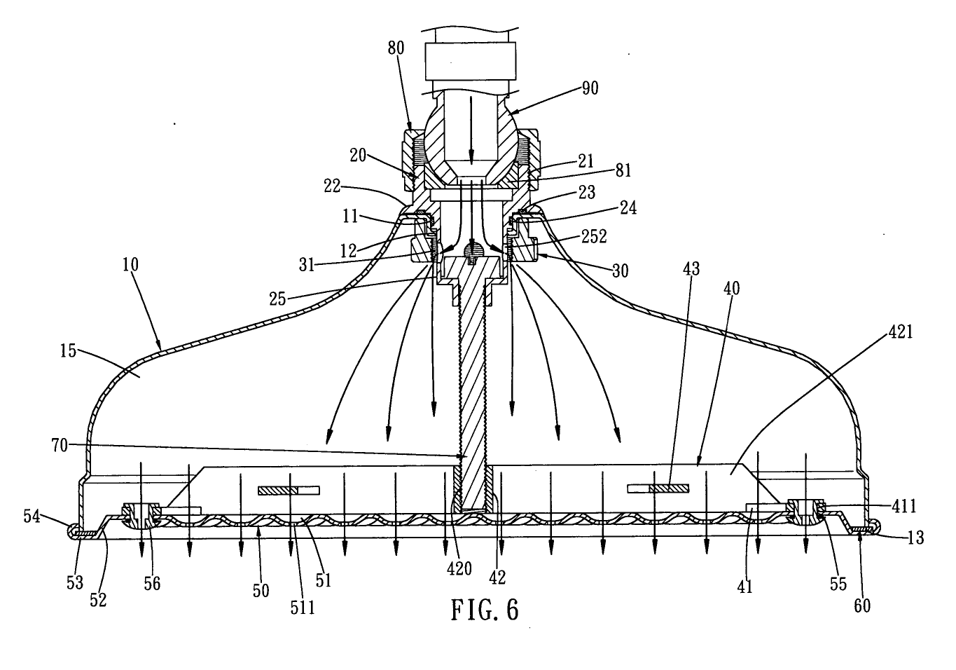

As shown in FIG. 6, the water from the wall flows through the universal connector 90 and the water inlet holes 252 of the locking seat 20 into the inside 15 of the main body 10, then passes through the mounting disk 40 and finally flows outward from the water outlet holes 511 and the nozzles 56 of the water outlet panel 50 for use.

Accordingly, the mounting disk 40 and the water outlet panel 50 are pulled to move upward by rotation of the adjusting bolt 70 to closely press the sealing ring 60 between the end flange 13 of the main body 10 and the support section 53 of the water outlet panel 50, so that the water outlet panel 50 is combined with the main body 10 closely without producing leak, thereby providing a sealing effect efficiently. In addition, the mounting disk 40 is combined with the water outlet panel 50, and the mounting ring 43 of the mounting disk 40 provides a hanging effect during the plating process, thereby facilitating the plating working process of the shower head assembly. Further, the mounting disk 40 and the water outlet panel 50 are removed from the main body 10 by rotation of the adjusting bolt 70, thereby facilitating a user cleaning the water outlet holes 511 and the nozzles 56 of the water outlet panel 50. Further, the water directly flows through the water inlet holes 252 of the locking seat 20 into the inside 15 of the main body 10, and directly flows outward from the water outlet holes 511 and the nozzles 56 of the water outlet panel 50, so that the water flow rate is smooth and constant.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A shower head assembly, comprising a main body, a locking seat, a water outlet panel, a mounting disk, and an adjusting bolt, wherein:
the main body has a central portion formed with a mounting recess having a side formed with a positioning hole;
the locking seat is mounted on the main body and has a first end formed with a mounting portion secured in the positioning hole of the main body and having a peripheral wall formed with a plurality of water inlet holes each communicating with an inside of the main body;
the water outlet panel is mounted on the main body and has a surface formed with a plurality of water outlet holes each communicating with the inside of the main body;
the mounting disk has a central portion formed with a column having an inside formed with a screw bore, a peripheral wall formed with an annular fixing ring secured on the water outlet panel and an intermediate portion formed with an annular mounting ring located between the column and the fixing ring; and
the adjusting bolt is rotatably mounted in the mounting portion of the locking seat and has a distal end screwed into the screw bore of the column of the mounting disk to pull the mounting disk and the water outlet panel to move upward.

2. The shower head assembly in accordance with claim 1, wherein the positioning hole of the main body has a square shape and has four chamfered corners.

3. The shower head assembly in accordance with claim 2, wherein the mounting portion of the locking seat has a square shape and has four chamfered corners to match a profile of the positioning hole of the main body.

4. The shower head assembly in accordance with claim 3, wherein each of the four chamfered corners of the mounting portion of the locking seat is formed with an outer threaded section.

5. The shower head assembly in accordance with claim 1, further comprising a locking nut mounted in the main body and secured on the mounting portion of the locking seat to fix the locking seat on the main body, so that the main body is urged between the locking seat and the locking nut.

6. The shower head assembly in accordance with claim 5, wherein the locking nut has a stepped shape.

7. The shower head assembly in accordance with claim 5, wherein the mounting portion of the locking seat has four chamfered corners each formed with an outer threaded section, and the locking nut has an inside formed with an inner thread screwed onto the outer threaded sections of the mounting portion of the locking seat.

8. The shower head assembly in accordance with claim 1, wherein the main body has a peripheral wall formed with an end flange disposed at an upright state, the water outlet panel has a peripheral wall formed with an oblique section having a distal end formed with a horizontal support section rested on the end flange of the main body and having a distal end formed with a hook-shaped upward curved snapping section snapped onto the end flange of the main body.

9. The shower head assembly in accordance with claim 8, further comprising a sealing ring mounted between the end flange of the main body and the support section of the water outlet panel.

10. The shower head assembly in accordance with claim 1, wherein the locking seat has a mediate portion formed with a substantially arc-shaped abutment rested on a top of the main body.

11. The shower head assembly in accordance with claim 1, further comprising an O-ring mounted on a side of the abutment of the locking seat and urged on the main body.

12. The shower head assembly in accordance with claim 1, wherein the locking seat has a second end formed with an outer thread.

13. The shower head assembly in accordance with claim 1, wherein the mounting disk is secured on the water outlet panel and received in the main body.

14. The shower head assembly in accordance with claim 1, wherein the mounting ring of the mounting disk is located at a level greater than that of the fixing ring.

15. The shower head assembly in accordance with claim 1, wherein the column of the mounting disk has a peripheral wall formed with a plurality of radially arranged connecting ribs each extended through and combined with the mounting ring and the fixing ring to connect the column, the mounting ring and the fixing ring.

16. The shower head assembly in accordance with claim 1, wherein the water outlet panel has an edge formed with a plurality of through holes, and the fixing ring of the mounting disk has a peripheral wall formed with a plurality of fixing holes combined with the through holes of the water outlet panel by a plurality of nozzles.

17. The shower head assembly in accordance with claim 1, wherein the mounting recess of the main body has a circular shape.

18. The shower head assembly in accordance with claim 1, wherein the locking seat has a triple-stepped cylindrical shape.

19. The shower head assembly in accordance with claim 1, further comprising an O-ring mounted on a side of the mounting portion of the locking seat and urged on a wall of the mounting recess of the main body.

20. The shower head assembly in accordance with claim 1, wherein the mounting portion of the locking seat has a stepped-shape cross-section and is inserted into the mounting recess of the main body.
